(19) United States
(12) Patent Application Publication
(10) Pub. No.: US 2011/0075210 A1
(43) Pub. Date: Mar. 31, 2011

(54) INFORMATION PROCESSING APPARATUS, METHOD FOR CONTROLLING THE SAME, AND STORAGE MEDIUM

(75) Inventor: Nobuaki Fukasawa, Tokyo (JP)

(73) Assignee: CANON KABUSHIKI KAISHA, Tokyo (JP)

(21) Appl. No.: 12/891,579

(22) Filed: Sep. 27, 2010

(30) Foreign Application Priority Data
Sep. 29, 2009 (JP) 2009-225568

(51) Int. Cl. G06F 3/12

(52) U.S. Cl. 358/1.15

(57) ABSTRACT

The number of process flows to be registered is reduced and the number of user's operations is reduced in specifying the process flow. A method for controlling an information processing apparatus for executing information processing according to a process flow previously defining a procedure for the information processing includes storing, in a storing unit, a predetermined condition and change information for changing a part of the information processing defined in the process flow in a case where the predetermined condition is satisfied, determining whether the predetermined condition is satisfied, and executing the process flow after a part of the information processing defined in the process flow is changed using the change information if it is determined that the predetermined condition is satisfied.

### BACKGROUND OF THE INVENTION

1. Field of the Invention

The present invention relates to an information processing apparatus, method for controlling the same, and a storage medium.

2. Description of the Related Art

In recent years, there has been known an information processing apparatus such as an image forming apparatus which is capable of previously registering a process flow defining a procedure for information processing including a plurality of processes. The information processing apparatus improves user's work efficiency by registering a series of information processing required for repetitively executing on business, for example, as a process flow.

Japanese Patent Application Laid-Open No. 2008-052445, for example, discusses a method in which a button for selecting process flows to be executed is displayed on an operation panel of an image forming apparatus and the process flow corresponding to the button selected via the operation panel is analyzed. The image forming apparatus sequentially calls a service processing apparatus such as a copying machine, a facsimile machine, and a multifunction peripheral according to the contents described on the process flow to execute the process flow.

The above conventional technique, however, has the following problems. For example, if the image forming apparatus is caused to execute the previously registered process flow with a part thereof changed according to a predetermined condition such as an execution time zone, a process flow including the changed contents requires for newly registering to the image forming apparatus aside from the previously registered process flow. In this case, a large number of process flows only a part of the procedure of which is different, but the contents of which are almost the same may be registered. As a result, for example, if any of the registered process flows is executed, the user needs to identify and select a desired process flow from a large number of process flows, so that a user's burden may be increased.

### SUMMARY OF THE INVENTION

According to an aspect of the present invention, an information processing apparatus for executing information processing according to a process flow defining a procedure for the information processing, includes a storing unit configured to store a predetermined condition and change information for changing a part of the information processing defined in the process flow in a case where the predetermined condition is satisfied, a determining unit configured to determine whether the predetermined condition is satisfied, and an executing unit configured to execute the process flow in which a part of the information processing is changed after the part of the information processing defined in the process flow is changed using the change information if it is determined that the predetermined condition is satisfied.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of an information processing system according to the exemplary embodiment of the present invention.

FIG. 2 is a block diagram illustrating an example of a configuration of a personal computer (PC) according to the exemplary embodiment of the present invention.

FIG. 3 is a block diagram illustrating an example of a configuration of an image forming apparatus according to the exemplary embodiment of the present invention.

FIG. 4 illustrates an example of an operation screen displayed on a user interface (UI) of the image forming apparatus according to the exemplary embodiment of the present invention.

FIG. 5 illustrates an example of a setting file and a condition file related to a process flow according to the exemplary embodiment of the present invention.

FIG. 6 illustrates an example of conditions which can be specified as conditions in a case where the process flow according to the exemplary embodiment of the present invention is changed.

FIG. 7 is a flow chart illustrating a procedure for setting a condition for changing the process flow and change information according to the exemplary embodiment of the present invention.

FIG. 8 is a flow chart illustrating a procedure for displaying and executing the process flow according to the exemplary embodiment of the present invention.

FIG. 9 illustrates an example of an operation screen for setting conditions and change information in the image forming apparatus according to the exemplary embodiment of the present invention.

FIG. 10 illustrates an example of an operation screen for setting conditions and change information in the image forming apparatus according to the exemplary embodiment of the present invention.

### DESCRIPTION OF THE EMBODIMENTS

Various exemplary embodiments, features, and aspects of the invention will be described in detail below with reference to the drawings.

An exemplary embodiment of the present invention is described below. The exemplary embodiment described below will help understand various conceptions such as an upper, a middle, and a lower conception of the present invention. The technical scope of the present invention is defined by the appended claims, but not limited by the following exemplary embodiment.

### [Configuration of an Information Processing System 10]

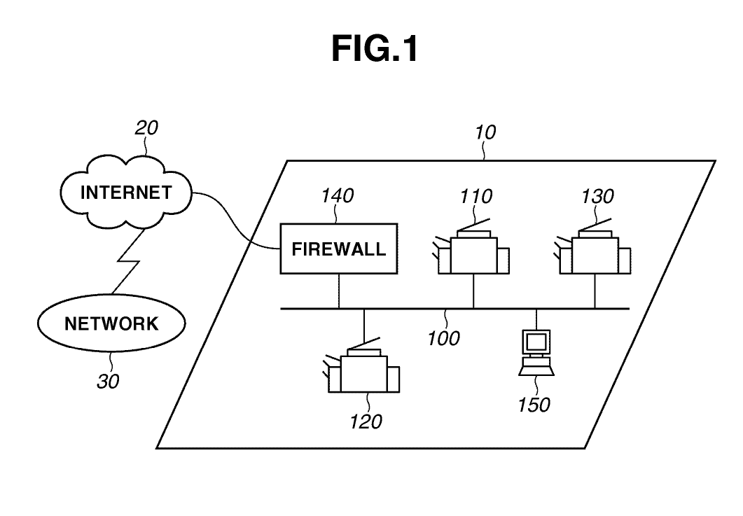

An example of a configuration of an information processing system 10 is described below with reference to FIG. 1. The information processing system 10 includes, for example, image forming apparatuses 110, 120, and 130 and a PC 150 which are connected to one another via a local area network (LAN) 100. The LAN 100 is connected to the Internet 20 on the outside via a fire wall 140. The image forming apparatuses 110, 120, and 130 and the PC 150 can be connected to the Internet 20 and another network 30 via the fire wall 140.

The image forming apparatuses 110, 120, and 130 are a multifunction peripheral (MFP) or a single function peripheral (SFP), for example, and have various information processing functions such as copy, print, send, and box. (In the following description, the image forming apparatus is exemplified.) The PC 150 is a general personal computer. The number of the image forming apparatus and the PCs are not limited to that thereof illustrated in FIG. 1. Any number of the image forming apparatus and the PCs may be connected to the LAN 100. An information processing apparatus having various information processing functions different from those of the image forming apparatus as well as the apparatus illustrated in FIG. 1 may be connected to the information processing system 10 via the LAN 100.

A user can use various functions of the information processing system 10 illustrated in FIG. 1. The copy function to copy a document, for example, is realized as follows. The image forming apparatus 110 reads a document to be copied to acquire image data. The image forming apparatus 110 prints the acquired image data on paper. The user may cause the image forming apparatus 110 to transmit the image data to other image forming apparatus 120 or 130 to cause the image forming apparatus 120 or 130 to print. Such a function is referred to as a remote copy function.

The user may cause the PC 150 to transmit data to be printed to the image forming apparatus 110 and cause the image forming apparatus 110 to print the data. Such a function is referred to as a print function. The user can cause the image forming apparatus 110 to acquire data stored in the PC 150 via the LAN 100 and to print the data. Such a function is referred to as a pull printing function.

The user can use a send function of the image forming apparatus 110 which is used to convert a document image to electronic data and transmit the electronic data to the PC 150. In this case, the image forming apparatus 110 reads a document image to acquire image data. When destination is set to the PC 150, the image forming apparatus 110 transmits the image data to the PC 150 via the LAN 100 and the PC 150 stores the received image data. The user may cause the image forming apparatus 110 to convert a document image to electronic data and to store the electronic data therein. Such a function is referred to as a box storage function. The user can use a box send function in which the image data stored by the box storage function is transmitted to the PC 150 via the LAN 100.

### [Configuration of PC 150]

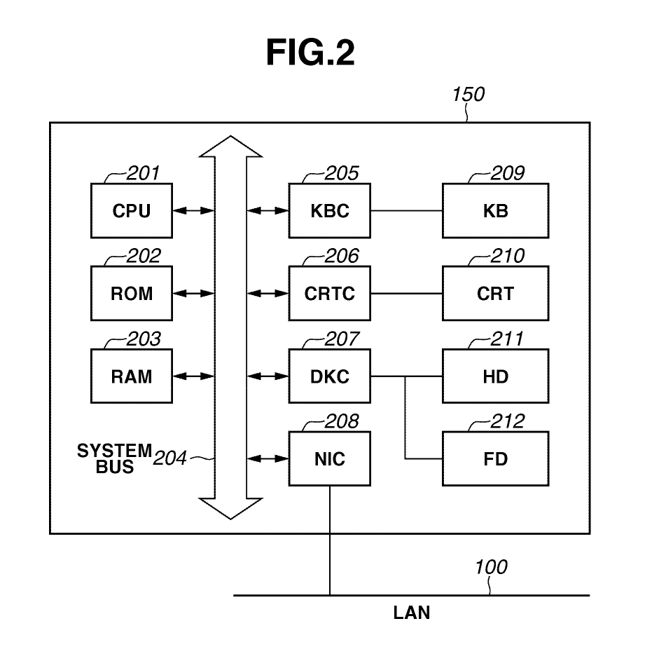

An example of the configuration of the PC 150 in the information processing system 10 is described below with reference to FIG. 2. In the PC 150, a central processing unit (CPU) 201 controls devices connected to a system bus 204. A random access memory (RAM) 203 is a main memory of the CPU 201 and functions as a work area of the CPU 201. The CPU 201 reads various types of software stored in a read-only memory (ROM) 202 or a hard disk (HD) 211 to the RAM 203 and executes the software. The CPU 201 can read software stored in an external storage medium such as a floppy disk drive (FD) 212 to the RAM 203 and execute the software.

A keyboard controller (KBC) 205 transmits an instruction input by the user controlling and operating a keyboard (KB) 209 or a pointing device (not illustrated) to the CPU 201. A cathode ray tube display (CRT) controller (CRTC) 206 controls display on a CRT display (CRT) 210. A disk controller (DKC) 207 realizes access control of the hard disk (HD) 211 and the floppy disk drive (FD) 212 which store a boot program, various applications, an editing file, and a user file. A network interface card (NIC) 208 is connected to the LAN 100 and bidirectionally transfers data between other network apparatuses (image forming apparatus and the like) and other PCs.

### [Configuration of Image Forming Apparatuses 110, 120, and 130]

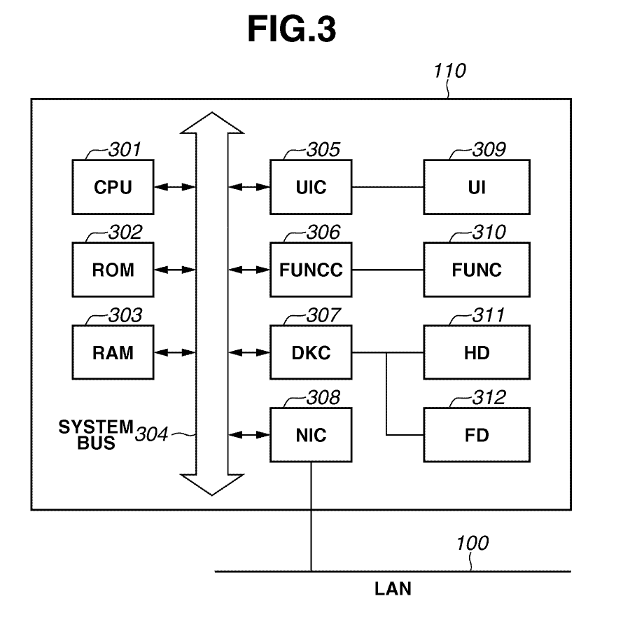

An example of the configuration of the image forming apparatuses 110, 120, and 130 is described below with reference to FIG. 3. In the following, the image forming apparatus 110 is described, however, each of the image forming apparatuses has the same configuration.

In the image forming apparatus 110, a CPU 301 controls devices connected to a system bus 304. A RAM 303 is a main memory of the CPU 301 and functions as a work area of the CPU 301. The CPU 301 reads various types of software stored in a ROM 302 or a hard disk (HD) 311 to the RAM 203 and executes the software. The CPU 301 can read software stored in an external storage medium such as a floppy (registered trademark) disk drive (FD) 312 to the RAM 303 and execute the software.

A user interface controller (UIC) 305 controls a user interface (UI) 309 to display on the UI 309 and receive the input of an instruction by the user via the UI 309. The UI 309 is a keyboard including a numerical keypad and a start key, a liquid crystal display (LCD) display unit, and a touch panel provided on the LCD display unit, for example. The user can input various instructions to the image forming apparatus 110 using the keyboard or the touch panel.

A function (FUNC) 310 is a function unit for realizing a specific function of the image forming apparatus 110. The FUNC 310 realizes the function under control of a function controller (FUNCC) 306.

For example, if the function is a monochrome print function, the FUNC 310 is a monochrome print engine and the FUNCC 306 is a monochrome print engine controller. If the function is a color print function, the FUNC 310 is a color print engine and the FUNCC 306 is a color print engine controller. If the function is a reading (scan) function, the FUNC 310 is a scanner and the FUNCC 306 is a scan controller. If the function is a FAX function, the FUNC 310 is a FAX interface and the FUNCC 306 is a FAX controller. It is needless to say that the image forming apparatus 110 may have a plurality of the functions. In that case, the image forming apparatus 110 includes a plurality of sets of the FUNCC 306 and the FUNC 310 corresponding to respective functions.

A disk controller (DKC) 307 realizes access control of the hard disk (HD) 311 and the floppy disk drive (FD) 212 which store a boot program, various applications, an editing file, and a user file. A network interface card (NIC) 308 is connected to the LAN 100 and bidirectionally transfers data between other network apparatuses such as other image forming apparatuses and other PCs.

### [Information Processing Based on Process Flow]

In the image forming apparatus 110, the CPU 301 and the UIC 305 performs control to display an operation screen on the UI 309. The user can input setting to the image forming apparatus 110 and issue an instruction to execute functions thereto by operating the touch panel provided on the UI 309 based on the operation screen displayed on the UI 309. For example, if the user executes the above described send function, the following processes are usually performed using the UI 309:
(1) execution of setting related to reading (i.e., reading setting) of an image such as resolution, destination of color/monochrome, a copy ratio, a reading density, and image quality;
(2) selection of a transmission method such as electronic mail and file transfer protocol (FTP);
(3) setting of a destination; and
(4) placement of a document on a document positioning plate and issuance of an instruction for execution.

If the user executes the send function, the user basically and always needs to perform the above processes. More specifically, if the user performs transmission to the same destination, the process using the same setting will be repeated which decrease process efficiency. Then, if the procedure for the process can be previously registered in the image forming apparatus 110 when the process using the same setting is repeated, the process efficiency can be improved.

For this reason, the image forming apparatus 110 has a function capable of executing the information processing according to a process flow in which the procedure for the information process such as image processing is predefined. The process flow is previously produced by a user's register operation via the UI 309 and stored in the HD 311. In the above examples, the setting related to the above (1) to (3) can be previously registered as a process flow. The user selects and executes the registered process flow to enable the image forming apparatus 110 to execute the process according to the process flow. Previously registering a frequently used function, for example, as a process flow allows the user to very easily use the function, thus user-friendliness can be improved. The process flow may be registered in the PC 150 not only using the UI 309 but also via the LAN 100, for example.

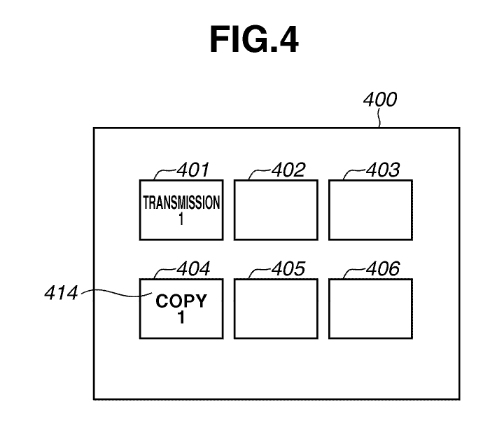

The image forming apparatus 110 can display an operation screen 400, for example, illustrated in FIG. 4 on the UI 309 as a list of the registered process flow. As an example, buttons 401 to 406 corresponding to the registered each process flow are displayed on the operation screen 400. Information (a name of a process flow and the like) that the user can recognize the corresponding process flow is indicated on each button. The user can instruct the image forming apparatus 110 to execute the process flow by pressing the button corresponding to the process flow desired to be executed based on the indication. In the operation screen 400, for example, the button 401 indicated as “transmission 1” corresponds to the foregoing send function. Therefore, the user places a document on a document positioning plate, presses the button 401 on the operation screen 400 using the UI 309 and then presses a start key to cause the image forming apparatus 110 to start the execution of the process flow corresponding to the function.

### [Change of Processing Flow by Setting Condition]

There may be a case where the previously registered processing flow is executed with a part thereof changed if a predetermined condition is satisfied in the image forming apparatus 110. This corresponds to a case where a destination is changed according to a time zone in the send function, for example. Thus, if the procedure for the processing defined in the process flow is executed with apart of the procedure changed, the process flow including the changed contents aside from the previously registered process flow needs to be newly registered in the image forming apparatus 110. This may register a large number of process flows the process procedure of which is partly different but almost the same in contents. Increase in the registered process flows may increase the number of buttons to be displayed on the operation screen 400 corresponding to the process flow, and for example, result increasing the user's burden in selecting any of the buttons.

The present exemplary embodiment permits registration of a condition in changing the process flow and change information for changing a part of process included in the process flow if the condition is satisfied associated with the process flow, aside from the pre-registered process flow. Accordingly, the number of the process flow to be registered and the user's burden can be reduced.

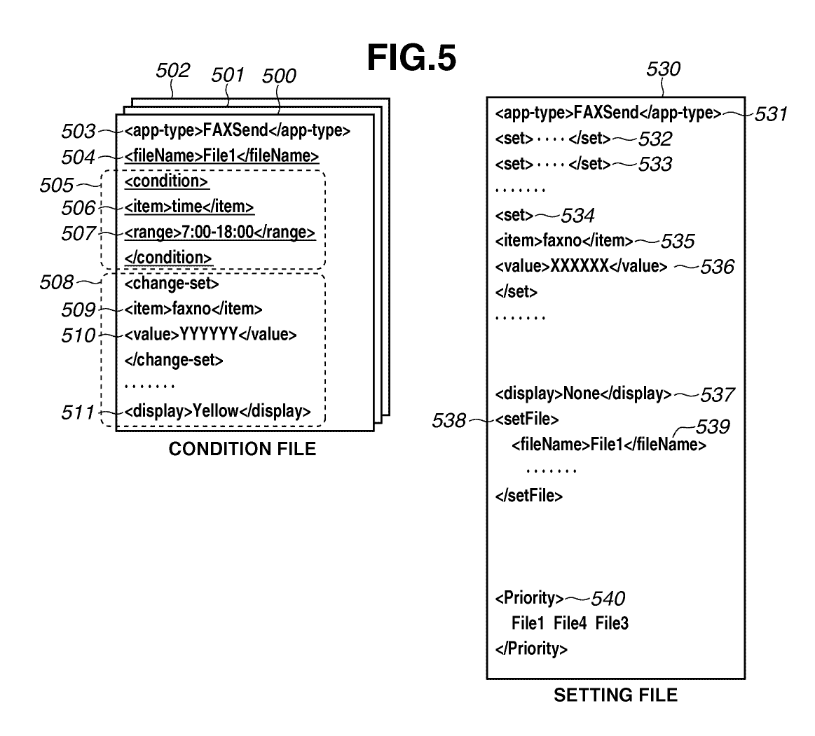

The process flow and the setting of conditions for changing the process flow are described below with reference to FIG. 5. In FIG. 5, a setting file 530 is an example of a file in which setting related to the process flow is described. Condition files 500, 501, and 502 are examples of files in which conditions associated with the process flow and the setting related to change information are described.

The setting file 530 includes a definition of the process flow related to the send function that an image data acquired by reading a document is used to perform a facsimile (FAX) transmission to a predetermined destination. The condition file 500 includes setting for changing the facsimile (FAX) number of a destination in a predetermined time zone in relation to the process flow. Although FIG. 5 illustrates a case where three of the condition and the change information are set to one setting file 530, the user can set any number of the condition and the change information.

A setting value (default value) in the case where none of conditions specified in the condition files 500, 501, and 502 are satisfied is previously described in the setting file 530. An item 531 is a type of an application corresponding to the process flow. “FAXSend” indicates the send function by FAX transmission.

Items 532 to 534 include setting values required for executing the process flow. The items 532 to 534 include, for example, reading setting in reading a document (such as resolution, designation of color/monochrome, a copy ratio, a reading density, and image quality) and information about destination. More specifically, the item 534 includes an item name 535 “faxno” indicating a setting value related to a FAX number of a destination and a setting value 536 “XXXXXX” thereof.

An item 537 indicates setting related to display color of the button corresponding to the process flow on the operation screen displayed on the UI 309. “None” indicates the use of a default value without specifying color.

As described below, if a condition set to the condition file is satisfied, a file name of the condition file is added to an item 538. In FIG. 5, “File1” indicating the condition file 500 is added which represents that the condition of the condition file 500 is satisfied. If the conditions of a plurality of the condition files are satisfied, the priority of the change information related to an item 537 among the items set to each condition file is set to an item 540. Here, “File1” is the highest in priority. Priority is set in the order of “File4 and “File3.”

On the other hand, a setting 505 related to the above conditions and a setting 508 related to the change information are described on the condition files 500, 501, and 502. An item 503 is a type of an application corresponding to the process flow and “FAXSend” being the same as in the process flow to be changed is described on the item 503. An item 504 denotes the file name of the condition file.

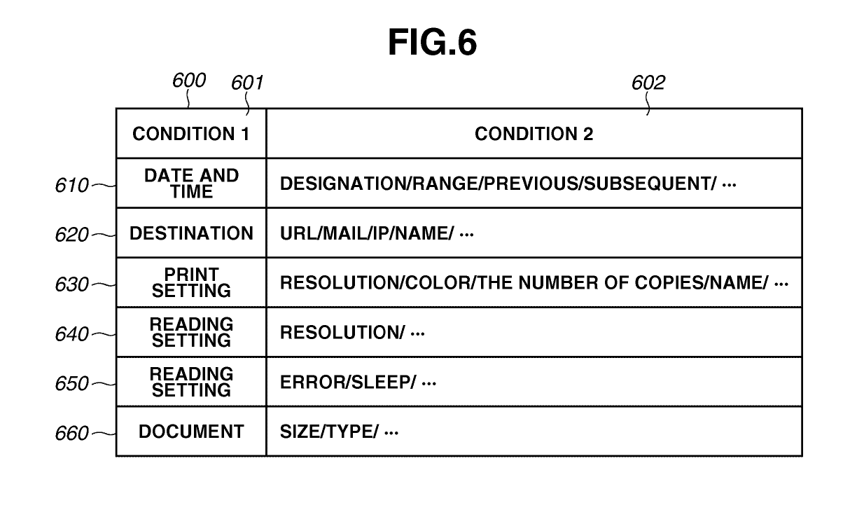

The setting 505 includes items 506 and 507 which are settings related to the conditions. The items 506 and 507 are the item name of a condition and the condition. FIG. 6 illustrates an example (600) of the condition in the case where the process flow is changed. A condition 1 (601) and a condition 2 (602) correspond to the items 506 and 507 respectively. As described below, the user can set specific conditions indicated in the condition 2 (602) for each category indicated in the condition 1 (601). In the condition file 500, as one example, “time” is set to the item 506 corresponding to the condition 1 (601) and “7:00-18:00” is set to the item 507 corresponding to the condition 2 (602) as “range.”

The setting 508 includes the change information for changing the setting file 530 related to the process flow if the condition of the setting 505 is satisfied. An item 509 is a name of an item to be changed and “faxno” is set thereto. An item 510 is change information for the item to be changed and “YYYYYY” is set thereto. An item 511 is a setting related to display color in displaying the button corresponding to the process flow associated with the condition file on the operation screen of the UI 309 if the condition of the setting 505 is satisfied. In this example, the display color is specified as “Yellow.”

When the condition set to the setting 505 of the condition file 500 is satisfied, the process for changing the contents of the setting file 503 based on the condition file is executed as follows, for example. The item name which is the same as that set in the item 509 in the setting 508 of the condition file 500 is searched from the setting file 530. In FIG. 5, the search identifies “faxno” of the item name 535 of the item 534. Then, the setting value 536 of “XXXXXX” included in the identified item 534 is changed to “YYYYYY.” Further, the file name (“File1” of the item 504) indicating the condition file in which conditions are satisfied is added to the item 538.

The above process is executed for all the created condition files 500, 501, and 502. Thereafter, the item 537 is changed in the setting (item 511) related to the display color corresponding to the condition file with the top priority based on the priority set in the item 540. In FIG. 5, since the condition file 500 is the highest in the priority, the item 537 is changed to “Yellow.” Thus, the button can be displayed in the display color set in the condition file with the top priority if the button corresponding to the setting file 530 is displayed by the UI 309.

A plurality of sets of item names to be changed and the change information may be set in the setting 508. In that case, the setting file 530 is changed using all the settings included in the setting 508 when the condition set in the setting 505 is satisfied.

### [Example of Condition Setting]

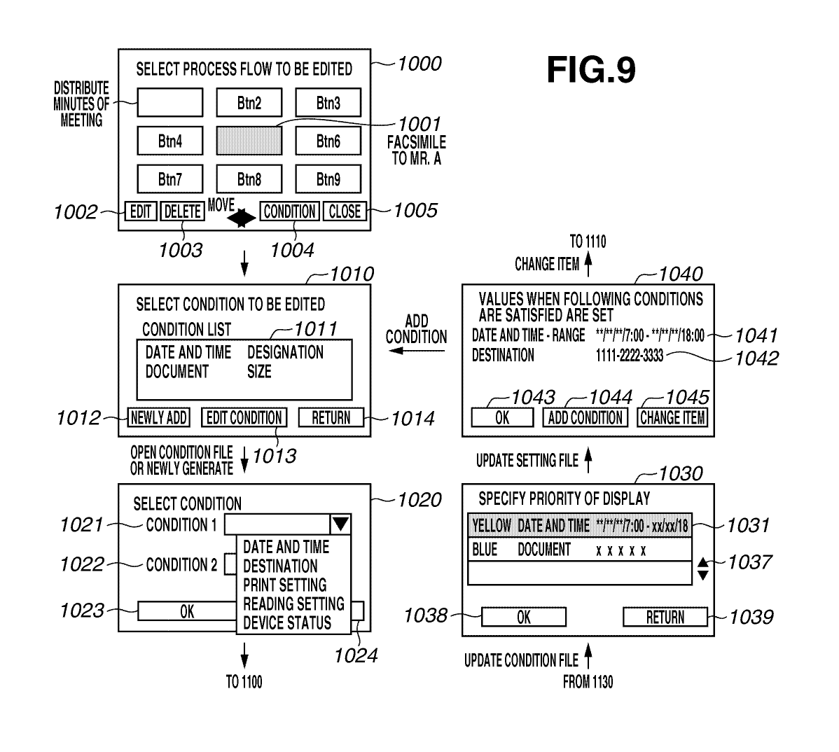

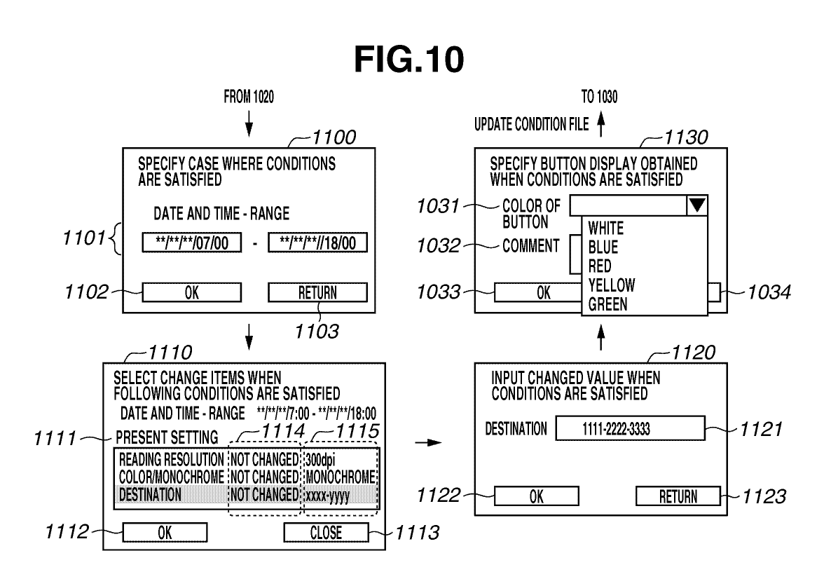

An example of setting a condition for creating the above described condition file is described below with reference to FIGS. 9 and 10. A screen 1000 is an example of a screen displaying a list of buttons corresponding to the registered process flows. Each of the registered process flows corresponds to each button. The screen 1000 indicates that the user pressed a button 1001 to select it. When a button 1002 is pressed in this state, the CPU 301 starts an editing process of the process flow corresponding to the button 1001. On the other hand, when a button 1003 is pressed, the CPU 301 starts a process for deleting the process flow corresponding to the button 1001. When a button 1004 is pressed, a screen 1010 is displayed to start a process for setting the condition of the selection button 1001. When a button 1005 is pressed, the CPU 301 closes the screen 1000.

The screen 1010 is a screen for displaying a list of conditions currently set on the process flow corresponding to the button selected on the screen 1000. The user can edit the set contents of the displayed condition or add a new condition using the screen 1010. When a button 1014 is pressed, the CPU cancels selection and displays the screen 1000. When a button 1012 is pressed, or when a button 1013 is pressed after any of the conditions is selected from a condition list 1011, the CPU 301 displays a screen 1020.

The screen 1020 is an example of a screen for editing the condition selected on the screen 1010 or specifying a new condition. The CPU 301 displays types of conditions which can be specified in a box 1021 in a pull-down form. The conditions correspond to the condition 1 in FIG. 6. The CPU 301 displays further specific conditions corresponding to the condition selected in the box 1021 in a pull-down form in a box 1022. The condition corresponds to the condition 2 in FIG. 6. When the conditions 1 and 2 are specified and a button 1023 is pressed, the CPU 301 displays a screen 1100. On the other hand, when a button 1024 is pressed, the CPU cancels the specified contents and displays the screen 1010.

The screen 1100 is an example of a screen for specifically setting the condition selected on the screen 1020. The example illustrates that “time” is specified as the condition 1 and “range” is specified as the condition 2. The range of “time” satisfying the condition is input to a box 1101. In the example, “7:00-18:00” on an arbitrary date is specified as the condition. When a button 1102 is pressed in this state, the CPU 301 sets the specified contents in concrete and displays a screen 1110. On the other hand, when a button 1103 is pressed, the CPU 301 cancels the specified contents and displays the screen 1020.

The screen 1110 is an example of the screen for specifying the setting to be changed in the process flow if the condition set on the screen 1100 is satisfied. A setting list 1111 indicates contents to be changed when the process flow is changed based on the created condition file. An item 1114 indicates whether there exists change. An item 1115 indicates the change information. The example shows that the change information satisfying the set conditions is not yet set for each of the set values of “reading resolution,” “color/monochrome,” and “destination” in the process flow. “Destination” is selected in the setting list 1111. When any of the items is selected from the setting list 1111 and a button 1112 is pressed, the CPU 301 displays a screen 1120. On the other hand, when a button 1113 is pressed, the CPU 301 cancels the selection and displays the screen 1100.

The screen 1120 is an example of the screen for setting the change information related to the setting selected on the screen 1110. In the example, a setting screen related to “destination” selected on the screen 1110 is displayed. When the destination is input to a box 1121 and a button 1122 is pressed, the CPU 301 displays a screen 1130. On the other hand, when a button 1123 is pressed, the CPU 301 cancels the contents input to the box 1121 and displays the screen 1110.

The screen 1130 is an example of the screen for the setting related to the display of a button on the operation screen if the set condition is satisfied. The CPU 301 displays color which can be specified as display color of the button corresponding to the process flow to be changed on a box 1131 in a pull-down form. The CPU 301 displays an input column for a comment which is additionally written, along with the button.

The contents set to the above are the ones of display control performed for the button in the operation screen if the condition set for the process flow to be changed is satisfied. More specifically, the CPU 301 highlights a corresponding button using the set display color or comments. If a button 1133 is pressed after the setting value is input, the CPU 301 creates a new condition file in which setting conditions are set or updates a file being edited with set contents and displays a screen 1030. On the other hand, when a button 1134 is pressed, the CPU 301 cancels the set contents and displays the screen 1120.

The screen 1030 is an example of the screen for the setting related to the display control of a button displayed on the operation screen if a plurality of conditions set for changing the process flow is satisfied. The CPU 301 displays a list 1031 of conditions set on the process flow in a form which can be recognized by the user. When any of the conditions is selected on the list 1031 and an up/down key 1037 is pressed, the priority of button display corresponding to the condition on the operation screen can be changed. In the list 1031, the condition existing in an upper position is higher in priority than the condition existing in a lower position. When a button 1038 is pressed, the CPU 301 determines the set contents and updates the condition file. On the other hand, when a button 1039 is pressed, the CPU 301 cancels the set contents and displays the screen 1130.

A screen 1040 is an example of a screen for confirming set conditions. In the example, “7:00-18:00” on an arbitrary date is displayed as a set content 1041 and as a set condition. Further, change information in which “destination” is changed to “1111-2222-3333” is displayed as change information 1042 associated with the condition. When a button 1043 is pressed, the CPU 301 stores the set content in the HD 311 to register the condition as the condition associated with the process flow and ends the editing process of the condition. When a button 1044 is pressed, the CPU 301 displays the screen 1010 and further, a condition can be added. When a button 1045 is pressed, change information can further be set if a condition being set is satisfied.

[Condition for Changing Process flow and Procedure for Setting Change Information]

The user can set a condition for changing the process flow and change information if the condition is satisfied, after the process flow is created and registered by an operation via the UI 309. The created process flow is stored in the HD 311 to be registered in the image forming apparatus 110.

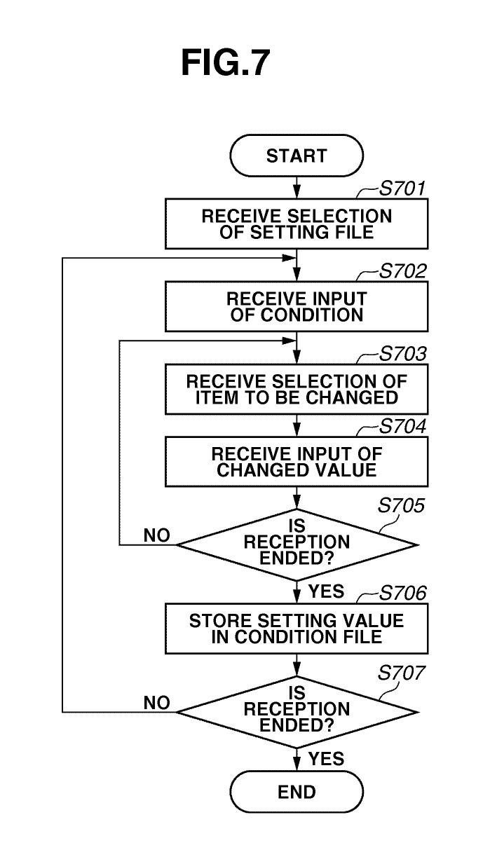

The procedure for setting a condition for changing the process flow and change information is described below with reference to FIG. 7. A flow chart illustrated in FIG. 7 is executed by the CPU 301 reading a program stored in the ROM 302 or the HD 311 of the image forming apparatus 110 to the RAM 203 and executing the program.

In step 5701, the CPU 301 displays a list of buttons as an operation screen (FIG. 4, for example) corresponding to the registered process flows (setting files) on the UI 309 and receives the selection of a process flow from the user via the operation screen. The processing proceeds to step 5702. The processing in step 5701 corresponds to the processing using the screen 1000.

In step 5702, the CPU 301 receives the input of a condition concerning the selected process flow via the UI 309. In step 5703, the CPU 301 receives the selection of an item to be changed via the UI 309. The processing proceeds to step S704. The processing in step S702 corresponds to the processing using the screens 1010, 1020, and 1100. The processing in step S703 corresponds to the processing using the screen 1110.

In step S704, if a condition set for the selected item is satisfied, the CPU 301 receives the input of change information for changing the item. The processing in step S704 corresponds to the processing using the screens 1120 and 1130. In step S705, the CPU 301 determines whether the selection of the item to be changed and the reception of the change information are ended based on the user's operation of the UI 309. If the CPU 301 determines that the selection and reception processing is ended (YES in step S705), the processing proceeds to step S706. If the CPU 301 determines that the selection and reception processing is not ended (NO in step S705), the processing returns to step S703 to continue the processing.

In step S706, the CPU 301 newly creates or updates a condition file based on the set condition and the change information to store the set value in the condition file and the HD 311. In step S707, the CPU 301 determines whether the reception of input of a condition is ended based on the user's operation of the UI 309. If the CPU 301 determines that the reception processing is ended (YES in step S707), the editing of the condition file for the process flow is ended. On the other hand, if the CPU 301 determines that the reception processing is not ended (NO in step S707), the processing returns to step 5702 to continue the processing.

[Display of Process flow and Procedure for Execution]

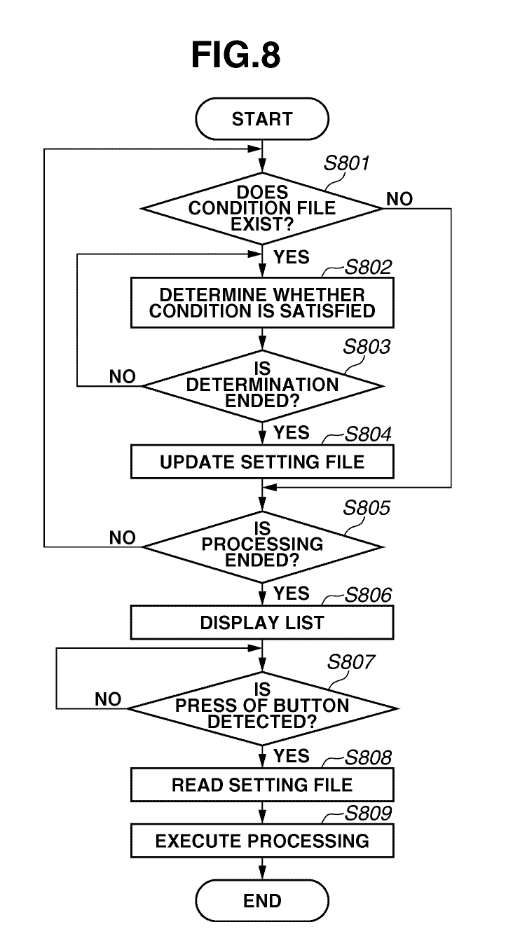

A display process on the UI 309 based on the process flow, the associated conditions, and the change information registered and stored in the HD 311, and a process for executing the process flow are described below with reference to FIG. 8. A flow chart illustrated in FIG. 8 is executed by the CPU 301 reading a program stored in the ROM 302 or the HD 311 of the image forming apparatus 110 to the RAM 203 and executing the program.

The CPU 801 starts the process for displaying a list of the registered process flow on the UI 309 like the operation screen 400 illustrated in FIG. 4. In step S801, the CPU 301 selects any of the process flows to be displayed on the UI 309 and determines whether there exists the condition file associated with the process flow. The determination process is realized by the CPU 301 searching the contents stored in the HD 311. If the CPU 301 determines that there exists the condition file (YES in step S801), the processing proceeds to step S802. If the CPU 301 determines that there does not exist the condition file (NO in step S801), the processing proceeds to step S805.

In step S802, the CPU 301 selects any of the condition files and determines whether the condition set on the file is satisfied and then the processing proceeds to step S803. In step S803, the CPU 301 confirms whether there exist files yet to be determined among the condition files to determine whether to end the determination process using the condition file.

If the CPU 301 determines that the determination process is ended because there is no file yet to be determined (YES in step S803), the processing proceeds to step S804. If the CPU 301 determines that the determination process is not ended because there exists files yet to be determined (NO in step S803), the processing returns to step S802. Through the process in steps S802 and S803, the CPU 301 executes the determination process of all the condition files associated with the process flow.

In step S804, the CPU 301 changes apart of the process to be changed included in the process flow using the change information associated with the determined condition if a predetermined condition is satisfied as a result of the above determination. In the changing process, a copied file may be changed and temporarily stored in the RAM 303 instead of overwriting the setting file of the process flow stored in the HD 311.

In step S805, the CPU 301 confirms whether there exists the process flow in which the determination process is not yet executed using the condition file among the process flows stored in the HD 311 to determine whether to end the process in steps S801 to S804. If the CPU 301 determines that the determination process is ended because the determination process is executed for all the process flows (YES in step S805), the processing proceeds to step S806. If the CPU 301 determines that the determination process is not ended because there exists the process flow in which the determination process is not yet executed (NO in step S805), the processing returns to step S801 to continue the processing.

In step S806, the CPU 301 displays the list of the registered process flow on the UI 309. At that point, the CPU 301 highlights the button corresponding to the process flow satisfying the predetermined condition using the display color set on the condition file. Along with display by the display color or instead thereof, comments set on the screen 1130 may be additionally displayed on the button. This can cause the user to clearly discriminate the process flow satisfying the predetermined condition from the list.

The CPU 301 may highlight a corresponding button for each process flow using at least one of the display color and the comment associated with the above predetermined condition with the top priority if a plurality of conditions among the associated conditions is satisfied. This allows the user to recognize that the process flow is in a state where the condition being high in priority for the user is satisfied.

In step S807, the CPU 301 determines whether to detect pressing down of any of the buttons corresponding to the process flows via the UI 309. If the CPU 301 determines that the button is pressed (YES in step S807), the processing proceeds to step S808. In step S808, if the process flow corresponding to the pressed button is subjected to the changing process based on the above determination process, the CPU 301 reads the changed setting file from the HD 311 or the RAM 303. If the process flow is not subjected to the changing process, the CPU 301 reads the setting file previously stored in the HD 311. In step S809, the CPU 301 executes the process in accordance with the definition using the process flow set on the read setting file. Thereafter, a series of the processes in the flow chart is terminated.

Thus, the above determination process for determining whether to satisfy the predetermined condition associated with the process flow has only to be executed at any timing before the list of the process flows is displayed on the UI 309 in step S806. This allows the CPU 301 to highlight the button corresponding to the processing flow which is changed based on the determination result.

The determination process may be periodically executed. In that case, the CPU 301 updates the highlight of the button displayed on the display unit according to the change result of the process flow based on the determination result. This enables the user to appropriately distinguish the process flow satisfying the predetermined condition by the highlight.

The above exemplary embodiment is merely an example, so that various modifications can be made. When the CPU 301 executes the process flow in step S809, for example, the CPU 301 may execute the above steps S801 to S805. More specifically, when the CPU 301 starts the execution of the process flow in which the pressing down of the button displayed on the UI 309 is detected, the CPU 301 may execute the determination process based on the predetermined condition, and change and execute the process flow according to the determination result. Although the above exemplary embodiment is described with the image forming apparatus taken as an example, even an information processing apparatus which can execute information processing according to the above process flow can carry out the present invention.

As described above, the information processing apparatus according to the present exemplary embodiment has a function to execute information processing according to the process flow in which the procedure for information processing is defined and previously stores a predetermined condition and change information by associating with the process flow. If the information processing apparatus determines that the predetermined condition is satisfied, the information processing apparatus changes a part of the process flow using the change information and executes the process flow.

More specifically, according to the exemplary embodiment of the present invention, there is no need for registering a plurality of the process flows different only in a part of the definition. The different parts are stored as pieces of the change information and the process flow is changed according to the predetermined condition using the change information and executed. Accordingly, the number of the process flows to be stored in the information processing apparatus can be decreased.

Since the number of the displaying buttons can be decreased when the buttons corresponding to the process flows are displayed on the display unit of the information processing apparatus, the user can easily identify a button corresponding to a desired process flow from a plurality of the displayed buttons. As a result, the user's burden can be reduced in specifying the process flow to be executed.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-225568 filed Sep. 29, 2009, which is hereby incorporated by reference herein in its entirety.

What is claimed is:

1. An information processing apparatus for executing information processing according to a process flow defining a procedure for the information processing, the information processing apparatus comprising:
a storing unit configured to store a predetermined condition and change information for changing a part of the information processing defined in the process flow in a case where the predetermined condition is satisfied;
a determining unit configured to determine whether the predetermined condition is satisfied; and
an executing unit configured to execute the process flow in which a part of the information processing is changed after the part of the information processing defined in the process flow is changed using the change information if it is determined that the predetermined condition is satisfied.

2. The information processing apparatus according to claim 1, further comprising:
a display control unit configured to display buttons corresponding to a plurality of the process flows on a display unit; and
a detecting unit configured to detect that the button displayed on the display unit is pressed by a user,
wherein the executing unit executes information processing according to the process flow corresponding to the button pressed by the user, and
wherein the display control unit displays the button corresponding to the process flow to be changed according to the change information.

3. The information processing apparatus according to claim 2, wherein the determining unit determines whether the predetermined condition associated with the process flow is satisfied before the buttons corresponding to the process flows are displayed on the display unit by the display control unit.

4. The information processing apparatus according to claim 2, wherein the determining unit periodically determines whether the predetermined condition is satisfied, and
wherein the display control unit displays the button corresponding to the process flow to be changed according to the change information which is determined to satisfy the predetermined condition.

5. The information processing apparatus according to claim 2, wherein the storing unit further stores at least one of a display color of the button displayed on the display unit and a comment displayed along with the button by associating with the predetermined condition and the change information, and
wherein the display control unit displays the button corresponding to the process flow to be changed according to the change information using at least one of the display color and the comment.

6. The information processing apparatus according to claim 5, wherein the storing unit further stores priority corresponding to each of a plurality of pieces of the change information, and
wherein the display control unit displays the button corresponding to the process flow to be changed according to the change information with the top priority using at least one of the display color and the comment associated with the change information with the top priority in a case where there exists a plurality of pieces of the change information which is determined to satisfy the predetermined condition by the determining unit.

7. The information processing apparatus according to claim 1, further comprising:
a display control unit configured to display a button corresponding to the process flow; and
a detecting unit configured to detect that the button displayed on the display unit is pressed by a user,
wherein the executing unit executes information processing according to the process flow corresponding to the button pressed by the user, and
wherein the determining unit determines whether the predetermined condition associated with the process flow is satisfied if the process flow is subjected to execution by the executing unit.

8. A method for controlling an information processing apparatus for executing information processing according to a process flow previously defining a procedure for the information processing, the method comprising:
storing, in a storing unit, a predetermined condition and change information for changing a part of the information processing defined in the process flow in a case where the predetermined condition is satisfied;
determining whether the predetermined condition is satisfied; and
executing the process flow after a part of the information processing defined in the process flow is changed using the change information if it is determined that the predetermined condition is satisfied.

9. A computer readable storage medium for storing a computer program for controlling an information processing apparatus for executing information processing according to a process flow previously defining a procedure for the information processing, the program comprising:
a code to store, in a storage unit, a predetermined condition and change information for changing a part of the information processing defined in the process flow in a case where the predetermined condition is satisfied;
a code to determine whether the predetermined condition is satisfied; and
a code to execute the process flow after a part of the information processing defined in the process flow is changed using the change information if it is determined that the predetermined condition is satisfied.
